(19) United States
(12) Patent Application Publication
(10) Pub. No.: US 2024/0341529 A1
(43) Pub. Date: Oct. 17, 2024

(54) Fryer With Continuous Filtration System And Removable Filter Assembly

(71) Applicant: WS Holdings, LLC, Colleyville, GA (US)

(72) Inventors: James R. Wixson, Roswell, GA (US); Howard D. Wixson, III, Colleyville, TX (US); Chad C. Wixson, Marietta, GA (US); Patrick B. Wixson, Marietta, GA (US)

(21) Appl. No.: 18/299,297

(22) Filed: Apr. 12, 2023

(51) Int. Cl. A47J 37/12

(52) U.S. Cl. CPC A47J 37/1223

(57) ABSTRACT

A fryer having a fry pot that holds cooking oil for cooking comestibles and an oil filtration system for filtering the cooking oil is provided. The fry pot includes a cold zone and a cooking zone. The oil filtration system includes a filter assembly that is movable between a lowered position wherein the filter is immersed within the cooking oil and located in the cold zone of the fry pot and a raised position wherein the filter is removed from the cooking oil. The filtration system further includes a pump fluidly connected to the filter assembly to apply a vacuum to the filter assembly to draw unfiltered cooking oil from the fry pot and return filtered cooking oil back to the fry pot. The pump is configured to apply the vacuum to the filter assembly while the filter assembly is moved between the lowered position and the raised position.

### FIELD OF THE INVENTION

This invention relates generally to the filtering of edible cooking oil for fryers and, more particularly, a continuous oil filtration system for a fryer.

### BACKGROUND OF THE INVENTION

Fryers are extensively used in the food industry to cook various foods and render them flavorful, colorful, and digestible. One common type of fryer is a deep fat fryer, which includes a heated vessel of edible cooking oil in which food items are placed for cooking. Depending on the application, deep fat fryers are sized to contain anywhere between one to thousands of gallons of heated cooking oil. Comestibles are cooked by being immersed in the cooking oil for a period of time before being removed. To adequately cook the comestibles, the cooking oil is typically heated in the vessel to a temperature between about 250º Fahrenheit (F) and about 375° F. (about 121° C. and about 190° C.), and in rare cases the cooking oil is heated to temperatures as high as 425° F.

Over time, as comestibles are continually introduced into the fryer and cooked, the cooking oil breaks down and becomes contaminated with particulate such as suspended food particles. More particularly, starches and proteins break down the cooking oil through chemical reaction with oxidation, polymerization, hydration, and other similar compounds that are catalysts in the degradation process of the cooking oil. One example of a contributor to the alteration and degradation of the cooking oil is food particles that become dislodged from comestibles during the cooking process and thereafter remain in the oil as particulate. Water and fats are extracted from the comestibles during the cooking process and remain in the oil, and any other contaminants such as free fatty acids, are other examples of possible contaminants that may alter the cooking characteristics of the cooking oil.

In addition to degrading the cooking oil, contaminants such as those mentioned above, if not removed from the cooking oil, will eventually become charred and will impart unwanted tastes, odors, and dark color to the cooking oil. Furthermore, such contaminants may attach themselves to comestibles during the frying process, thereby raising the potential for adversely affecting the taste of the comestibles and/or creating negative health issues upon consumption. Thus, it is necessary to filter out and remove these contaminants from the cooking oil to extend the useful life of the cooking oil and to maintain the integrity of comestibles being cooked. To address the above-described issues, many fryers have been developed with filtration systems to remove contaminants from the oil. However, these systems often require frequent shutdowns of the fryer to filter the cooking oil or to manually replace or clean the filter and/or filter system, which can be time-consuming and disrupt the frying process.

In view of the above, there is an increasing need for a fryer having a continuous oil filtration system and a removable oil filter to maintain the quality of the cooking oil with minimal disruptions to the frying process. In particular, there is a need for a filter assembly that can be easily removed from the fryer to be quickly cleaned or replaced without shutting down the fryer. Therefore, maintenance of the fryer can be performed quickly and efficiently while minimizing disruptions to the frying process.

### SUMMARY OF THE INVENTION

According to one aspect of the present invention, a fryer for cooking comestibles is provided. The fryer includes a fry pot having a chamber configured to hold a volume of cooking oil for cooking comestibles and an oil filtration system for filtering the cooking oil. The oil filtration system includes a filter assembly with a filter connected to a suction line such that the filter assembly is movable between a lowered position where the filter is immersed within the cooking oil and a raised position where the filter is removed from the cooking oil. The oil filtration system further includes a pump operatively connected to the filter assembly. In that regard, the pump includes an inlet port fluidly connected to the suction line of the filter assembly by an inlet line to receive filtered cooking oil from the filter assembly and the outlet port fluidly connected to the fry pot with a return line to direct filtered cooking oil to the chamber of the fry pot. The pump is configured to apply a vacuum to the filter assembly to draw unfiltered cooking oil from the fry pot and through the filter assembly for filtering and to pump the filtered cooking oil back to the chamber of the fry pot. In particular, the pump is configured to apply vacuum to the filter assembly while comestibles are being cooked and/or while the filter assembly is moved between the lowered position and the raised position.

According to another aspect of the invention, the filter assembly is substantially vertically oriented in the fry pot. In that regard, the filter assembly may be suspended in the fry pot by the suction line. Furthermore, the inlet line of the oil filtration system may include a telescopic section that provides for vertical movement of the filter assembly relative to the fry pot. According to one aspect, a liner actuator may be used to move the filter assembly between the lowered position and the raised position.

According to another aspect of the invention, the oil filtration system may include a suction pressure sensor for measuring a suction pressure in the inlet line. In that regard, the fryer may include a controller operatively coupled to the oil filtration system and a human machine interface operatively coupled to the controller. The controller may be configured to operate the oil filtration system as follows: monitor the suction pressure in the inlet line and, if the suction pressure drops below a first suction pressure value, generate a low suction pressure notification at the human machine interface. Where the fryer includes a liner actuator to move the filter assembly between the lowered position and the raised position, the controller may operate the oil filtration system with the additional following steps: if the suction pressure drops below the first suction pressure value, operate the linear actuator to move the filter assembly from the lowered position to the raised position.

According to one aspect of the invention, the inlet line of the oil filtration system includes a 2-way diverter valve fluidly connected to a batch filter unit by a batch filter line. Operation of the 2-way diverter valve places the batch filter unit in fluid communication with the inlet port of the pump.

According to another aspect of the present invention, a fryer for cooking comestibles is provided. The fryer includes a fry pot with a chamber that includes a cooking zone located at a first end of the chamber of the fry pot and a cold zone located at an opposite second end of the chamber of the fry pot. The cold zone and the cooking zone define a volume of the chamber of the fry pot configured to hold cooking oil for cooking comestibles. The fryer further includes at least one heating element located in the cooking zone of the chamber of the fry pot, a crumb basket configured to be located in the cold zone of the chamber of the fry pot, and a filter assembly suspended within the fry pot by a suction line such that a filter of the filter assembly is partially positioned within the cold zone for filtering cooking oil.

According to another aspect, the filter assembly is substantially vertically oriented in the fry pot. For example, the filter may be positioned within the crumb basket. Furthermore, a majority of the filter may be positioned within the cold zone of the chamber of the fry pot. In that regard, the cold zone may extend downwardly from the cooking zone to form a deepest point of the fry pot. To this end, the fry pot may include a drain that extends from a base wall portion of the fry pot that defines the cold zone.

According to one aspect of the invention, the filter is an envelope filter that defines a pocket configured to receive a separator screen. In that regard, the pocket of the filter is in fluid communication with the suction line.

According to yet another aspect of the invention, a fryer for cooking comestibles is provided. The fryer includes a fry pot with a chamber configured to hold a volume of cooking oil for cooking comestibles and an oil filtration system for filtering the cooking oil. The oil filtration system includes a filter assembly disposed within the fry pot such that a filter of the filter assembly is immersed within the cooking oil. The filter assembly includes a suction line with a first end connected to the filter and a second end positioned outside the fry pot such that the suction line extends from the first end upwardly through a top opening of the fry pot to the second end. The oil filtration system further includes a pump operatively connected to the filter assembly. In that regard, the pump includes an inlet port fluidly connected to the second end of the suction line of the filter assembly by an inlet line to receive filtered cooking oil from the filter assembly and an outlet port fluidly connected to the fry pot with an outlet line to return filtered cooking to the chamber of the fry pot. The positive displacement pump circulates the cooking oil through the oil filtration system by applying a vacuum to the filter assembly to draw unfiltered cooking oil held in the cooking chamber of the fry pot through the filter assembly for filtering thus pumping filtered cooking oil back to the chamber of the fry pot. To this end, the filter assembly may be substantially vertically oriented in the fry pot.

According to one aspect of the invention, the inlet line of the oil filtration system includes a telescopic section that provides for vertical movement of the filter assembly relative to the fry pot. In that regard, the filter assembly may be movable between a lowered position where the filter is immersed within the cooking oil and a raised position where the filter is removed from the cooking oil while being in constant fluid communication with the positive displacement pump.

According to another aspect, the oil filtration system includes a suction pressure sensor for measuring a suction pressure in the inlet line. In that regard, the fryer may further include a controller operatively coupled to the oil filtration system and a human machine interface operatively coupled to the controller. The controller may be used to operate the oil filtration system as follows: monitor the suction pressure in the inlet line and, if the suction pressure drops below a first suction pressure value, generate a low suction pressure notification at the human machine interface. According to another aspect of the invention, the fryer includes a liner actuator for moving the filter assembly between the lowered position where the filter is immersed within the cooking oil and the raised position wherein the filter is removed from the cooking oil. In that regard, the controller may be used to operate the oil filtration system as follows: monitor the suction pressure in the inlet line and, if the suction pressure drops below the first suction pressure value, operate the linear actuator to move the filter assembly from the lowered position to the raised position.

According to yet another aspect of the invention, the inlet line of the oil filtration system includes a 2-way diverter valve fluidly connected to a batch filter unit by a batch filter line. To this end, operation of the 2-way diverter valve places the batch filter unit in fluid communication with the inlet port of the pump.

### BRIEF DESCRIPTION OF THE DRAWINGS

The accompanying drawings, which are incorporated in and constitute part of this specification, illustrate embodiments of the invention and, together with the summary of the invention given above, and the detailed description of the drawings given below, explain the principles of the present invention. These illustrations are not to construe the extent to which the filter assembly can be integrated with fry frying equipment. This invention can be in any configuration where oil is being filtered from a fryer with a positive displacement vacuum or positive pressure pump, for example.

FIG. 1 is a perspective view of a fryer equipped with an oil filtration system having a filter assembly for filtering cooking oil held in a fry pot of the fryer during frying operations according to an embodiment of the invention.

FIG. 1A is a cross-sectional view of the fryer showing the location of the telescopic section of the inlet line.

FIG. 2 is perspective view of the filter assembly, illustrating a quick connect coupling between a suction line of the filter assembly and a telescopic section of the oil filtration system of the fryer.

FIG. 3 is a cross-sectional view of the fryer of FIG. 1, illustrating additional details of the oil filtration system and further illustrating the manually removable filter assembly in a lowered position for filtering the cooking oil.

FIG. 3A is a cross-sectional view of the fryer like FIG. 3 but illustrating a different removable filter assembly in a lowered position for filtering the cooking oil.

FIG. 3B is a cross-sectional view of the telescopic section of the oil filtration system of the fryer of FIGS. 1-3, illustrating engagement between a slide member and a stationary member of the telescopic section.

FIG. 3C is a cross-sectional view of the filter assembly of FIGS. 1-3, illustrating details of a filter for filtering the cooking oil.

FIG. 4 is a cross-sectional view of the fryer that is similar to FIG. 3, but illustrating the filter assembly in a raised position.

FIG. 5 is a perspective view of another embodiment of fryer equipped with an oil filtration system having a filter assembly for filtering cooking oil held in a fry pot of the fryer during frying operations and a linear actuator to raise and lower the filter assembly.

FIG. 6 is a cross-sectional view of the fryer of FIG. 5.

FIG. 7 is a schematic representation of the oil filtration system according to both embodiments of the invention.

### DETAILED DESCRIPTION OF THE INVENTION

Aspects of the present invention are directed to a continuous oil filtration system for a fryer, and more particularly, an in-vessel filter assembly that forms part of the continuous oil filtration system for continuously filtering cooking oil held in a fry pot of the fryer during frying operations. By “in-vessel” filter assembly, it is meant that at least the filter of the filter assembly is immersed within the cooking oil held in the fry pot for filtering operations. In one embodiment, the fryer includes a fry pot having a chamber having a cooking zone and a cold zone that together define a volume of the chamber of the fry pot that is configured to hold cooking oil for cooking comestibles. The cold zone provides a deep well area that is isolated from the cooking zone for trapping crumbs and other particles that become dislodged from food during the cooking process to prevent degradation of the cooking oil. In that regard, a temperature of the cooking oil in the cold zone is lower compared to a temperature of the cooking oil in the cooking zone to prevent further cooking and eventual burning or charring of food particles that fall into the cold zone. The filter of the filter assembly is configured to be positioned generally vertically within the fry pot. In one embodiment, the filter is positioned generally vertically within the cold zone and specifically within a crumb basket located within the cold zone for filtering the cooking oil held in the fry pot. To this end, the filter assembly is vertically removable from an open top of the fry pot for cleaning or for replacement of the filter envelope which can be performed without the need to stop cooking operations. These and other aspects of the present invention will be described in further detail below.

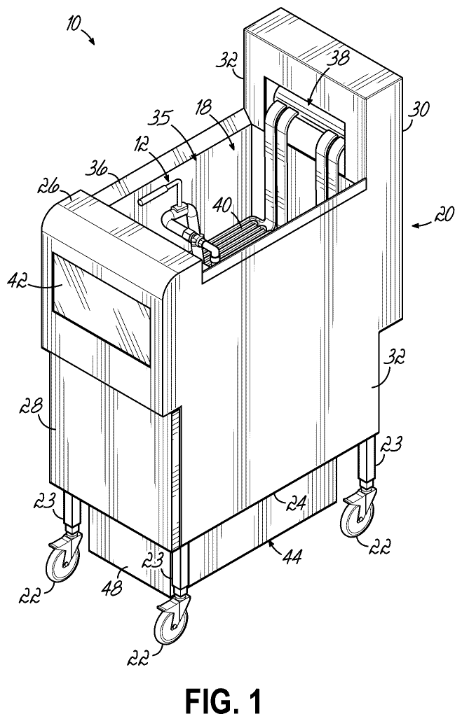

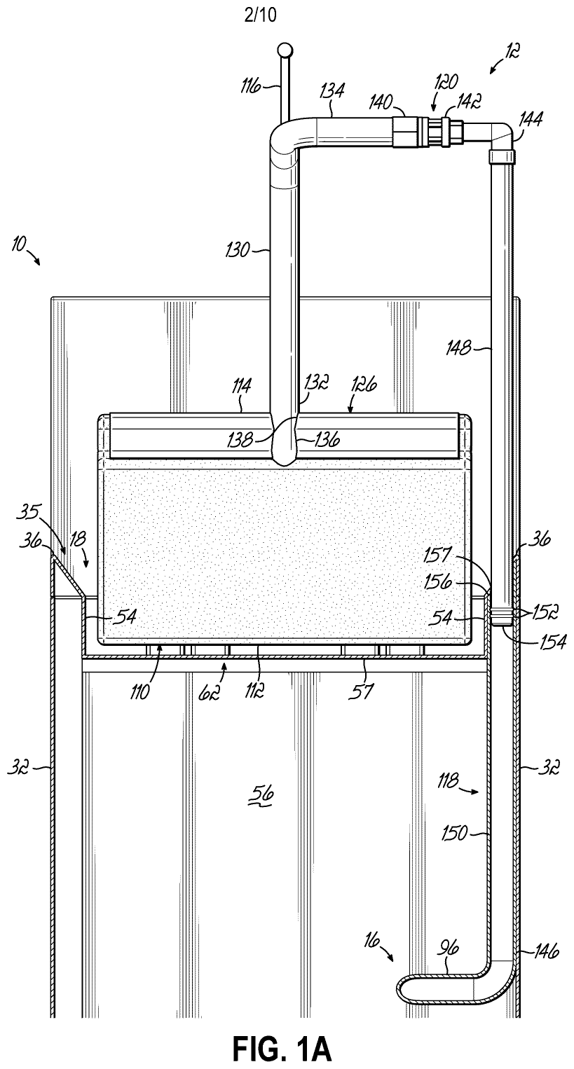

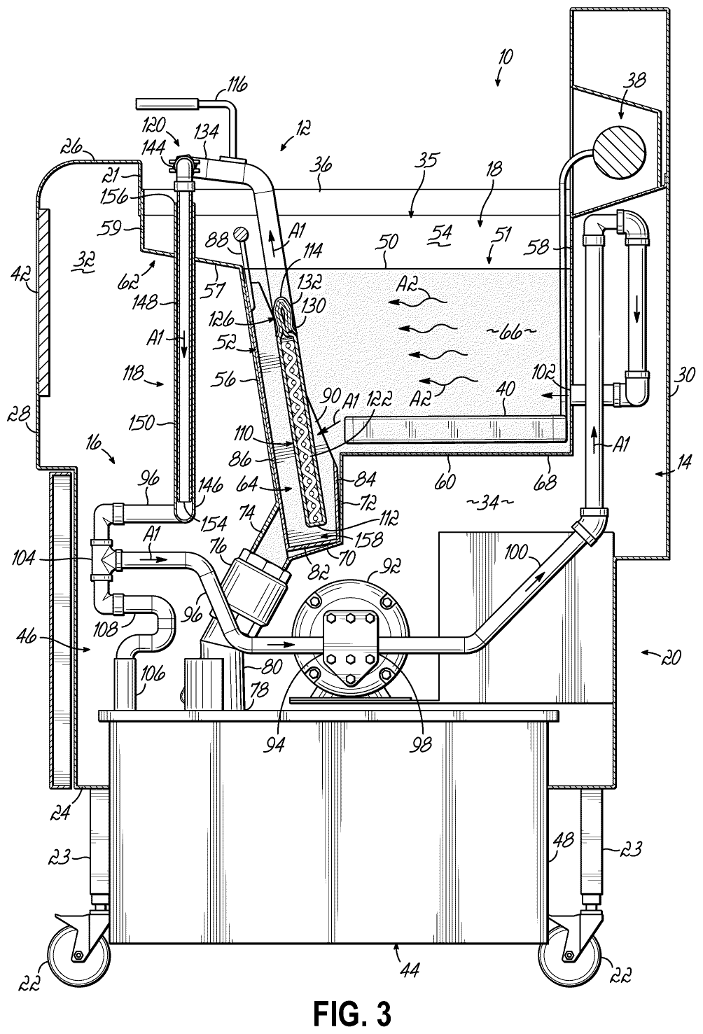

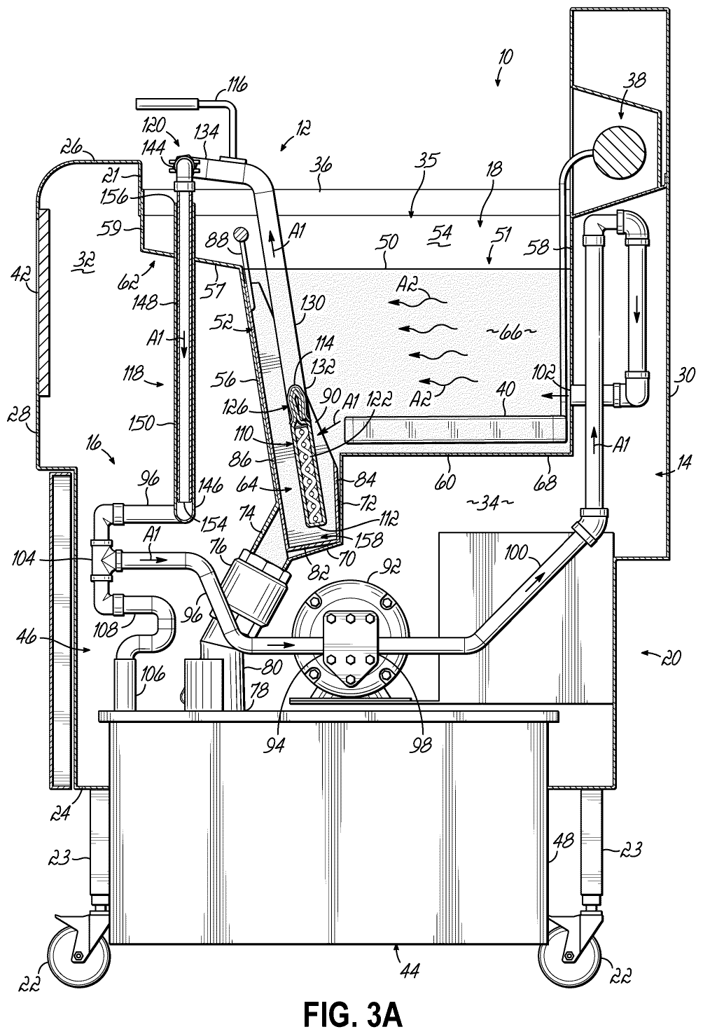

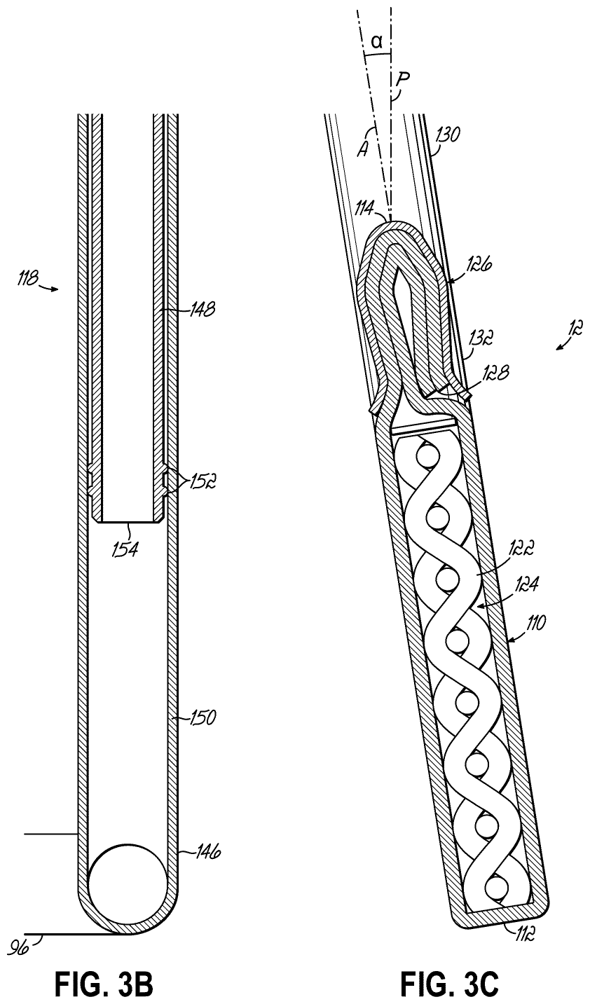

With reference to FIG. 1, details of an exemplary fryer 10 equipped with a filter assembly 12 that forms part of an oil filtration system 14 (e.g., FIG. 3) of the fryer 10 in accordance with a first embodiment of the invention are shown. In particular, the filter assembly 12 forms part of a continuous oil filtration system or loop 16 (e.g., FIG. 3) of the fryer 10 for continuously filtering cooking oil held in a fry pot 18 of the fryer 10 during frying operations, as will be described in further detail below. In that regard, the fryer 10 may be considered a recirculating fryer. While aspects of the present invention are shown and described in the context of a specific fryer design, it will be understood that the same inventive concepts related to aspects of the present invention may be implemented with different fryer designs and cooking oil filtration applications and systems without departing from the scope of the present invention. To this end, the drawings are not intended to be limiting.

As shown in FIG. 1, the exemplary fryer 10 is a portable deep fat fryer having a housing 20 movably supported by a plurality of legs 23. At the bottom of each of the legs 23 is a wheel 22, such as swivel caster. Although one type of leg 23 and one type of wheel 22 are illustrated, the fryer 10 may have any other type of legs or wheels. The drawings are not intended to be limiting. The wheeled housing 20 includes a base 24, a top 26, a front 28, a back 30, and sidewalls 32 that together define an interior 34 of the fryer 10 that contains certain components of the oil filtration system 14. The fry pot 18 is positioned inside the interior 34 of the fryer 10 near the top 26 of the fryer 10 such that a top opening 35 of the fry pot 18 is accessible for inserting and removing comestibles for cooking in the fry pot 18. In that regard, the fry pot 18 is configured to accommodate a food basket (not shown) for cooking comestibles. The food basket may be located in a cooking zone of the fry pot 18, as will be described in further detail below. The fryer 10 includes a heat source 38 electronically coupled to one or more heating elements 40. The one or more heating elements 40 is/are/may be located within the fry pot 18 and below the surface of cooking oil for heating the cooking oil. The one or more heating elements 40 may be a gas or electric heater(s) located within the fry pot 18, for example. Alternatively, the one or more heating elements 40 may be external to the fry pot 18, such as a gas, electric, or induction heat exchanger(s) located in the oil return line, for example.

With continued reference to FIG. 1, the fryer 10 includes a control panel 42 where appropriate control equipment (i.e., one or more controllers) for components of the fryer 10 are located. The control panel 42 may be where a Human Machine Interface (HMI) is located, for example. To this end, according to embodiments of the present invention, components of the fryer 10, including embodiments of the present invention, are responsive to stored programs for commanding operation of those components. The programs may be computer-readable program instructions for carrying out operations of the embodiments of the present invention. The computer-readable programs may be assembly language, source code, or object code written in any combination of one or more programming languages, and may be implemented using one or more computing devices or systems which may include a processor, a memory, an input/output (I/O) interface, and a Human Machine Interface (HMI), for example.

The exemplary fryer 10 further includes a removable batch filter assembly 44 located under the fryer 10 at the base 24 of the housing 20, as shown in FIGS. 1 and 3. The batch filter assembly 44 may be removable from the fryer 10. In either case, the batch filter assembly 44 forms part of a batch oil filtration system or loop 46 (e.g., FIG. 3) of the fryer 10 and includes a holding tank 48 for receiving the volume of cooking oil held in the fry pot 18 during a batch filter operation. In that regard, during normal operation of the fryer 10, the filter assembly 12 is suspended within the fry pot 18 to filter cooking oil 50 from the fry pot 18 which is then circulated through the continuous oil filtration loop 16 and back into the fry pot 18. At the end of a period of use for the fryer 10, the operator may desire to run a batch filter operation where the entire contents of the fry pot 18 are filtered while the fryer is not being used to cook food. During a batch filter operation, the entire contents of the fry pot 18 are emptied into the holding tank 48 of the batch filter assembly 44 and subsequently filtered and pumped back to the fry pot 18 via the batch filtration loop 46. In that regard, the batch filter assembly 44 may be the filtering system described in U.S. patent application Ser. No. 17/584,687 (owned by the Assignee of the present disclosure), the disclosure of which is expressly incorporated herein by reference in its entirety. To this end, the oil filtration system 14 of the fryer 10 is a combination continuous and batch filtration system.

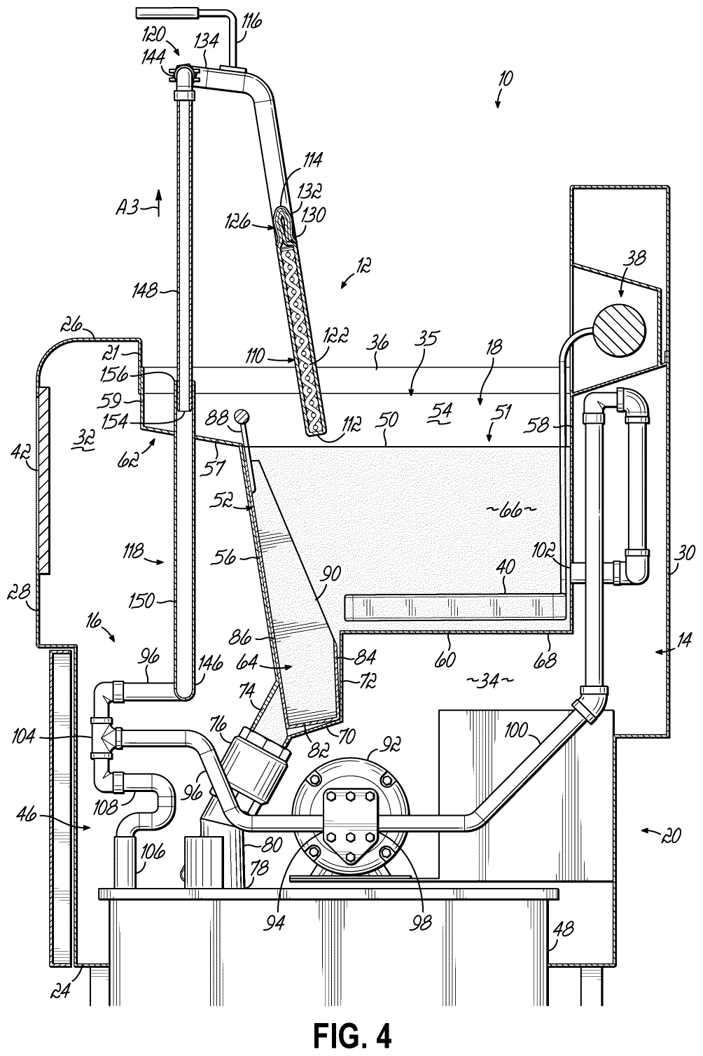

As briefly described above, and referring now to FIGS. 1 and 3, the fry pot 18 is configured to hold a volume of cooking oil 50 for cooking comestibles. Furthermore, the fry pot 18 is configured to receive a crumb basket 52 (see FIGS. 3 and 4) for collecting and effecting removal of crumbs and other byproducts of the cooking process. The crumb basket 52 is permeable to liquid and typically made of stainless steel but may be made of any other known metal. The filter assembly 12 is configured to be received within the fry pot 18 and disposed at least partially within the crumb basket 52, as shown in FIG. 3, to filter the cooking oil 50 as will be described in further detail below. The fry pot 18 further includes a pair of sidewalls 54, a front wall 56, a front wall extension 57, a joining flange 59, a rear wall 58, a base wall 60, and a tapered top rim 36 that together define a chamber 51 for holding the volume of cooking oil 50. The top rim 36 is tapered downwardly towards the interior or chamber 51 of the fry pot 18. The joining flange 59 is welded or otherwise connected to a flange 21 extending downwardly from the top 26 of the housing 20 at the front of the housing 20.

The chamber 51 of the fry pot 18 includes a generally L-shaped drip-catch or drain pan section 62 that extends upwardly from the front wall extension 57 and rearwardly from the joining flange 59 of the fry pot 18. The drip-catch 62 is configured to direct any oil drippage from removing the crumb basket 52 or filter assembly 12 from the fry pot 18, for example, back into the fry pot 18. To this end, the drip-catch 62 is a receiving portion of the fry pot 18.

As shown, the fry pot 18 is recessed into the housing 20 of the fryer 10 and extends from the top opening 35 of the fry pot 18 located at the top 26 of the fryer 10 to the base wall 60 of the fry pot 18. The linear distance between the top 26 of the fryer 10 and the base wall 60 of the fry pot 18 defines a depth of the fry pot 18. The fry pot 18 has a length defined as the linear distance between the front wall 56 of the fry pot 18, which is located adjacent the front 28 of the fryer 10, and the rear wall 58 of the fry pot 18, which is located adjacent to the back 30 of the fryer 10. Lastly, the fry pot 18 has a width defined as the linear distance between the sidewalls 54 of the fry pot 18.

As shown in FIG. 3, the configuration of the fry pot 18 defines the chamber 51 having a cold zone 64 at the front of the fry pot 18 and a cooking zone 66 at the rear of the fry pot 18. The cold zone 64, the drip catch 62, and the cooking zone 66 may, together, define a volume of the fry pot 18 configured to hold cooking oil 50 for cooking comestibles. In particular, the base wall 60 of the fry pot 18 is generally step-shaped and includes an upper base wall portion 68 that extends from the rear wall 58 of the fry pot 18 forwardly to a sidewall portion 72 which extends downwardly to a lower base wall portion 70 that extends to the front wall 56 of the fry pot 18. The upper base wall portion 68 and the lower base wall portion 70 are connected by the sidewall portion 72. The sidewall portion 72, the lower base wall portion 70 and a lower portion of the front wall 56 of the fry pot 18 define a deep well pocket that forms the cold zone 64 of the fry pot 18. In that regard, the cold zone 64 forms the deepest point of the fry pot 18. The cold zone 64 is configured to receive a lower portion of the crumb basket 52 and provides a deep well area for trapping crumbs and other particles that become dislodged from food during the cooking process to prevent degradation of the cooking oil 50. As shown, the cooking zone 66 is located above the cold zone 64 and is generally defined by the rear wall 58, the upper base wall portion 68, the sidewalls 54, and a portion of the front wall 52 of the fry pot 18. The one or more heating elements 40 are positioned over the upper base wall portion 68 of the fry pot 18 so as to be located in the cooking zone 66 for heating the cooking oil 50 inside the chamber 51 of the fry pot 18. To this end, the cooking basket holding comestibles may be located in the cooking zone 66 in the space above the one or more heating elements 40 inside the chamber 51 of the fry pot 18.

The cold zone 64 is located below the cooking zone 66 so as to be isolated from the cooking zone 66 and oil flow within the cooking zone 66. The isolated configuration of the cold zone 64 provides for optimal trapping of crumbs and other particles in the removeable perforated crumb basket 52 and the filter assembly located partially in the crumb basket 52. The crumbs and other particles that become dislodged from food during the cooking process get caught by the removeable perforated crumb basket 52, thereby removing contaminates from the cooking zone 66 to prevent degradation of the cooking oil 50. In that regard, a temperature of the cooking oil 50 in the cold zone 64 is lower compared to a temperature of the cooking oil 50 in the cooking zone 66 to prevent further cooking and eventual burning or charring of food particles that fall into the cold zone 64. For example, a temperature of cooking oil 50 in the cold zone 64 may be low as 250° F. or 121° C. when the temperature of cooking oil 50 in the cooking zone 66 is typically 350° F. or 176° C.

With continued reference to FIG. 3, the fry pot 18 further includes a drain 74 that extends downwardly from the lowest point of the fry pot 18. More specifically, the drain 74 extends downwardly from the deep well pocket that forms the cold zone 64 of the interior or chamber 51 of the fry pot 18. In the embodiment shown, the drain 74 and the fry pot 18 are formed together as a unitary piece. Specifically, the drain 74 extends from the cold zone 64 pocket such that the front wall 56 and the lower base wall portion 70 of the fry pot 18 form continuous extensions of the drain 74. Specifically, the lower base wall portion 70 of the fry pot 18 is angled downwardly from horizontal to facilitate the flow of cooking oil 50 into the drain 74. The drain 74 includes a valve 76 and is configured to be connected to an inlet port 78 of the batch filter assembly 44 via a drain line 80. The valve 76 is for selectively controlling the flow of cooking oil 50 to the batch filter assembly 44, such as for a batch filter operation, as described above. To this end, the valve 76 may be a manual valve or a solenoid actuated control valve. The operation of the valve 76 may be controlled via the control panel 42 of the fryer 10.

With continued reference to FIG. 3, the crumb basket 52 is sized to be received within the fry pot 18, and in particular the deep well pocket that forms the cold zone 64. That is, the crumb basket 52 is form fit to be received within the cold zone 64. In that regard, a base 82 of the crumb basket 52 may generally correspond to a size of the lower base wall portion 70 of the fry pot 18, a front wall 84 of the crumb basket 52 may generally correspond to a size of the sidewall portion 72 of the fry pot 18, and a rear wall 86 of the crumb basket 52 may generally correspond to a size of the front wall 56 of the fry pot 18. The crumb basket 52 includes a handle 88 for removing and installing the crumb basket 52 in the fry pot 18. Although one configuration of handle 88 is shown, the crumb basket 52 may have any other configuration of handle; the drawings are not intended to be limiting. When the crumb basket 52 is positioned in the cold zone 64 (e.g., FIG. 3), an opening 90 of the crumb basket 52 is configured to generally face the rear wall 58 of the fry pot 18 to facilitate the flow of crumbs and other particulate into the crumb basket 52 for collection. As will be described in further detail below, the filter assembly 12 is configured to be located within the cold zone 64 and disposed within the crumb basket 52 for filtering the cooking oil 50 held in the fry pot 18.

With continued reference to FIG. 3, additional details of the oil filtration system 14 of the fryer 10 are shown and will now be described. In that regard, the fryer 10 further includes a pump 92 located in the interior 34 of the fryer housing 20 for drawing oil through the filter assembly 12 and for pumping or circulating the filtered cooking oil 50 back into the fry pot 18. The pump 92 is also used to pump oil 50 held in the batch filter assembly 44 back into the fry pot 18 during a batch filter operation. The pump 92 may be a motor driven positive displacement pump such as an internal or external gear pump, lobe pump, or vane pump, for example. As the case may be, the pump 92 includes an inlet port 94 fluidly connected to the filter assembly 12 via an inlet line 96 and an outlet port 98 fluidly connected to the fry pot 18 via a return line 100. The return line 100 is connected to one or more oil return ports 102 formed in the rear wall 58 of the fry pot 18. As shown, the one or more oil return ports 102 are located proximate the base wall 60 of the fry pot 18 and the one or more heating elements 40 so that filtered cooking oil 50 returning to the fry pot 18 is immediately exposed to the one or more heating elements 40 for heating.

During cooking operation of the fryer 10, the fryer 10 may be selectively run in a continuous filter mode in which the pump 92 is operated to filter the cooking oil 50 by removing unfiltered cooking oil 50 from the fry pot 18 via the filter assembly 12 and circulating filtered cooking oil 50 through the continuous oil filtration loop 16 and back to the fry pot 18. In particular, the pump 92 applies a vacuum to the filter assembly 12 to draw unfiltered cooking oil 50 held in the fry pot 18 through the filter assembly 12, as indicated by directional arrows A1. The filtered cooking oil 50 is pumped through the inlet line 96, through the pump 92, and circulated through the return line 100 back to the fry pot 18. Flow of cooking oil 50 in that regard is through the continuous oil filtration loop 16 of the oil filtration system 14.

Operation of the pump 92 when the fryer 10 is in its continuous filter mode creates a substantial current within the cooking oil held in chamber 51 of the fry pot 18, as indicated by directional arrows A2. As shown, cooking oil 50 held in the chamber 51 of the fry pot 18 is moved in a direction A2 from the rear wall 58 of the fry pot 18 to the front wall 56 of the fry pot 18. This movement or current A2 is created from cooking oil 50 being drawn through the filter assembly 12 near the front wall 56 of the fry pot 18 and pumped back into the fry pot 18 via the one or more oil return ports 102 at the rear wall 58 of the fry pot 18. Movement of cooking oil 50 within the fry pot 18, as illustrated by the current A2, strips a cold barrier that surrounds comestibles thereby causing the comestibles to cook more quickly. This provides a crisper, juicer, more flavorful product. To this end, the current A2 may take on a convection-like flow pattern within the fry pot 18 to heat the comestibles within the chamber 51 of the fry pot 18 in an efficient manner.

As briefly described above, the cold zone 64 is located below the cooking zone 66 to isolate the cooking oil 50 contained in the cold zone 64 from the moving cooking oil 50 in the current flow A2 in the cooking zone 66. During frying operations, the oil current flow A2 pushes crumbs and other particulates toward the front wall 56 of the fry pot 18 and toward the deep well pocket that forms the cold zone 64. The crumbs and other particulates eventually fall out of the oil current flow A2 (or are pulled out of the cooking oil 50 onto the filter, e.g., arrows A1) and into the cold zone 64 where they are held in the crumb basket 52. This greatly reduces the amount of crumb buildup on the bottom of the fry pot 18. Furthermore, as a temperature of the cooking oil 50 in the cold zone 64 is lower compared to a temperature of the cooking oil 50 in the cooking zone 66, further cooking and eventual burning or charring of food particles that fall into the cold zone 64 is prevented. To this end, quickly removing contaminates from the cooking zone 66 greatly extends the useful life of the cooking oil 50.

With continued reference to FIG. 3, the inlet line 96 of the oil filtration system 14 further includes a diverter valve 104 located upstream of the pump 92. The diverter valve 104 may be a manual 2-way valve or a solenoid operated 2-way control valve, for example. The diverter valve 104 is configured to vary the flow of cooking oil 50 between the fry pot 18 and the pump 92, such as during the continuous filter mode, or from the batch filter assembly 44 to the pump 92, such as during a batch filter operation. In that regard, the diverter valve 104 is fluidly connected to an outlet port 106 of the batch filter assembly 44 by a batch filter line 108. To that end, during a batch filter operation, the diverter valve 104 is operated to place the batch filter line 108 in fluid communication with the pump 92. The pump 92 is then operated to pump the cooking oil 50 filtered by the batch filter assembly 44 back into the fry pot 18 via the return line 100. Flow of cooking oil 50 in that regard is through the batch oil filtration loop 46 of the oil filtration system 14.

Referring now to FIGS. 1A-4, details of the filter assembly 12 will now be described. The filter assembly 12 is configured to be substantially vertically oriented in the fry pot 18 such that a filter 110 of the filter assembly 12 is immersed within the cooking oil 50 held in the chamber 51 of the the fry pot 18. By “substantially” vertically, it is meant that the filter assembly 12 has a central axis “A” which is offset at an angle “a” with a vertical a plane “P”. The angle “a” is within a range of between +/−20° from vertical, as shown in FIG. 3C, for example. As shown in FIGS. 3 and 3A, the filter 110 of the filter assembly 12 may be any desired size. FIG. 3A illustrates the filter 110 being shorter than the filter 110 show in FIG. 3. The drawings are not intended to be limiting. The filter 110 may be any desired length.

The filter assembly 12 includes a handle 116 and, in the embodiment shown, is manually movable in the vertical direction relative to the fryer 10 and fry pot 18. Although one configuration of handle 116 is shown, the filter assembly 12 may have any other configuration of handle; the drawings are not intended to be limiting. In particular, the filter assembly 12 is movable between a lowered position, wherein at least a portion of the filter 110 of the filter assembly 12 is immersed within the cooking oil 50 (e.g., FIG. 3), and a raised position, wherein the filter 110 is removed from the cooking oil 50 (e.g., FIG. 4). While the exemplary fryer 10 is shown with one filter assembly 12, it is within the scope of the invention to include more than one filter assembly 12, such as two or more. To that end, one filter assembly 12 may be operational while another filter assembly 12 is being replaced or cleaned.

With reference to FIGS. 1A, 2 and 3, the filter assembly 12 is removably connected to the inlet line 96 of the continuous oil filtration loop 14, and in particular to a telescopic section 118 of the inlet line 96, via a quick connect coupling 120. The quick connect coupling 120 forms a fluid tight seal between the filter assembly 12 and the telescopic section 118 of the inlet line 96 and allows for the filter assembly 12 to be quickly replaced, if needed. As shown, the quick connect coupling 120 is positioned outside of the fry pot 18 and away from the cooking oil 50 so that replacement of the filter assembly 12 may be performed during frying operations, for example. In particular, the quick connect coupling 120 allows for quick and easy removal of the filter assembly 12 from the fryer 10, in a tool-less manner, so that the filter assembly 12 may be replaced or other maintenance activities performed on the filter assembly 12. The telescopic section 118 of the inlet line 96 is attached to the fryer housing 20 and extends proximate to the top opening 35 of the fry pot 18. The telescopic section 118 allows for the vertical movement of the filter assembly 12, as will be described in further detail below.

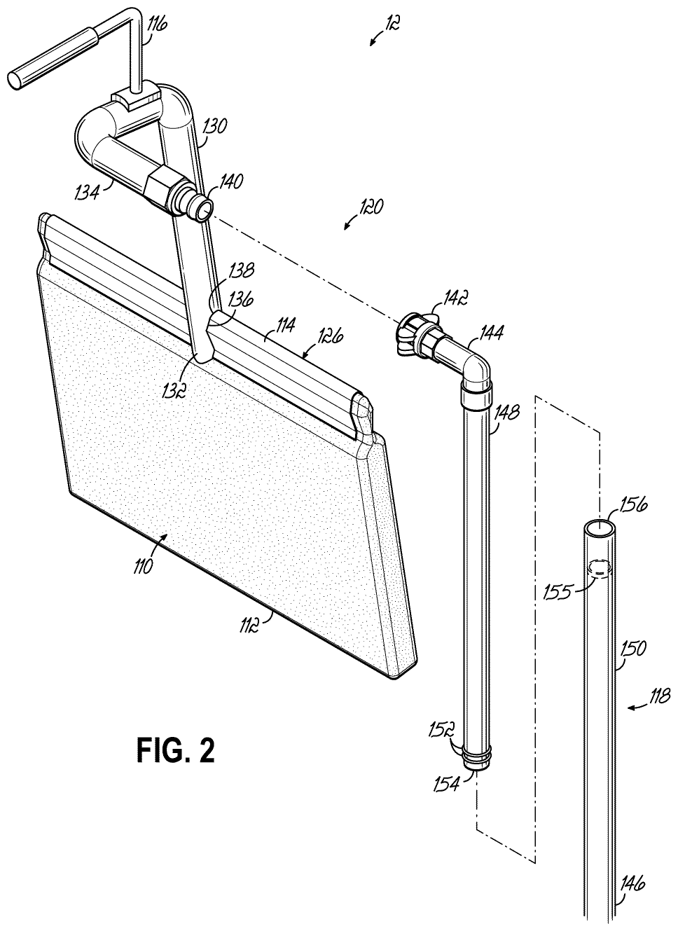

With reference to FIGS. 2 and 3C, the filter assembly 12 includes the filter 110 which, in the embodiment shown, is an envelope-type filter configured to receive a separator screen 122 therein. The separator screen 122 (otherwise referred to as a support screen, support plate, or separator plate) is configured to allow free flow of liquid (i.e., cooking oil) within a pocket 124 of the filter 110. The filter assembly 12 further includes a retention clip 126 that is configured to seal closed an open end 128 of the filter 110 and a suction line 130 fastened to the filter 110 to draw filtered oil through the filter 110, as will be described in further detail below. As best shown in FIG. 3C, the open end 128 of the filter 110 is folded and held closed by the retention clip 126 to enclose the separator screen 122 within the pocket 124. By sealing closed the open end 128 of the filter 110, a vacuum may be applied to the filter 110 by the pump 92 to pull cooking oil 50 through the filter 110 and into the pocket 124 of the filter 110. The filtered cooking oil 50 is then pumped from the pocket 124 through the suction line 130 and back to the chamber 51 of the fry pot 18, as described above.

The filter 110 may be constructed from one or more panels of non-woven polyphenylene sulfide (PPS) material as described in the above-referenced U.S. patent application Ser. No. 17/584,687. To this end, the PPS material from which the filter 110 is made is capable of filtering particulate down to 0.5 micron from cooking oil having a filtration temperature of up to 425° F., and can further withstand exposure to high temperatures (e.g., up to) 425° for an extended period of time without degradation to the non-woven micro-fiber structures that form the panel(s) of PPS material of the filter 110.

With reference to FIGS. 2 and 3, the suction line 130 includes a first or lower end 132 fastened to the filter 110 and a second or upper end 134 configured to be coupled to the telescopic section 118 of the inlet line 96. The first end 132 of the suction line 130 includes a pair of opposed slots 136 configured to receive a portion of the filter 110 so that the suction line 130 may be fastened to the filter 110 and placed in fluid communication with the pocket 124 of the filter 110. The retention clip 126 may include a notch 138 that cooperates with the slots 136 in the suction line 130 to facilitate connection of the suction line 130 to the filter 110. The second end 134 of the suction line 130 includes a male quick connect fitting 140 that is removably connectable to a corresponding female quick connect fitting 142 on the telescopic section 118 of the inlet line 96. The male and female quick connecting fittings 140, 142 form the quick connect coupling 120 described above. The suction line 130 may have one or more bends, such as bends of 90° or greater, for example, between the first end 132 and the second end 134.

As briefly described above, the filter assembly 12 is removably attachable to the telescopic section 118 of the inlet line 96 and vertically movable. In particular, the telescopic section 118 provides for vertical movement of the filter assembly 12. In that regard, the telescopic section 118 extends a length from a first or upper end 144 to a second or lower end 146 and includes a slide member 148 slideably received within a stationary member 150. The first end 144 of the telescopic section 118 of the inlet line 96 may be defined by the slide member 148 and the second end 146 of the telescopic section 118 of the inlet line 96 may be defined by the stationary member 150. As such, the slide member 148 includes the female quick connect fitting 142 and is attachable to the suction line 130 of the filter assembly 12 and the stationary member 150 is connected to the inlet line 96.

As shown in FIGS. 3-4, movement of the slide member 148 relative to the stationary member 150 varies a length of the telescopic section 118, and thus a length of the inlet line 96. As best shown in FIG. 3B, both the slide member 148 and the stationary member 150 are tubular, with the stationary member 150 having an inner diameter that is slightly larger compared to an outer diameter of the slide member 148. The fit between the slide member 148 and the stationary member 150 is fluid tight and may be a frictional fit, for example, that permits sliding or telescoping movement of the slide member 148 relative to the stationary member 150. As shown in FIG. 3B, to facilitate the fluid-tight seal between the slide member 148 and the stationary member 150, the slide member 148 includes one or more annular lip seals 152 adjacent an open end 154 of the slide member 148. In one embodiment, the one or more annular lip seals 152 may be an O-ring or gasket.

To prevent the slide member 148 from being inadvertently removed from the stationary member 150, a ring 155 may be located on the interior of the slide member 148 near an open end 156 of the stationary member 150. The ring 155 may be configured to abut one of the one or more annular lip seals 152 to prevent separation of the slide member 148 from the stationary member 150.

Although one type of ring 155 may be used to prevent separation of the slide member 148 from the stationary member 150, any other known apparatus used to prevent such separation may be used including a push pin assembly which passes through aligned holes (not shown) in the slide member 148 and the stationary member 150. This document is not intended to limit the apparatus used to prevent the slide member 148 from being pulled out of the stationary member 150 such that the two members are separated.

As shown in FIG. 1A, the stationary member 150 of the telescopic section 118 of the inlet line 96 is attached to the top rim 36 of the fry pot 18 and one of the sidewalls 32 of the housing 20 of the fryer 10 between the fry pot 18 and the sidewall 32 of the housing 20, such that the telescopic section 118 of the inlet line 96 is vertically oriented. In particular, the stationary member 150 may be attached to and contiguously welded to the top rim 36 of the fry pot 18 and sidewall 32 of the housing 20. Alternatively, the stationary member 150 may be attached to and contiguously welded to the top rim 36 of the fry pot 18 and sidewall 32 of the housing 20 with one or more fasteners, clamps, or the like. The open end 156 of the stationary member 150 is aligned with an opening 157 formed in the top rim 36 of the fry pot 18.

The slide member 148 of the telescopic section 118 of the inlet line 96 is movable through the opening 157 formed in the top rim 36 of the fry pot 18. Specifically, the slide member 148 is movable between a raised position shown in FIGS. 1A, 4 and 5 and a lowered position shown in FIG. 3. As shown in FIG. 3, when the slide member 148 is in its lowered position, the first or top end 144 of the telescopic section 118 is located at, or slightly above, the top opening 35 of the fry pot 18. As a result of this configuration, the quick connect coupling 120 between the telescopic section 118 and the filter assembly 12 is positioned near the front end 28 of the fryer 10 and generally over the drain pan section 62 of the chamber 51 of the fry pot 18. This provides for easy access to the filter assembly 12 for replacement or cleaning. Further, any oil drippage from replacing or cleaning the filter assembly 12 is drained back into the fry pot 18 via the drain pan section 62.

As briefly described above, the filter assembly 12 is vertically movable between at least a lowered position wherein the filter 110 is immersed within the cooking oil 50 and a raised position wherein the filter 110 is removed from the cooking oil 50. In that regard, FIG. 3 illustrates the filter assembly 12 in the lowered position. When so positioned, the filter assembly 12, and in particular the filter 110 and a portion of the suction line 130 are disposed within the chamber 51 of the fry pot 18. As shown in FIG. 3, the filter 110 of the filter assembly 12 is suspended within the fry pot 18 by the suction line 130. In that regard, the first end 132 of the suction line 130 is immersed in the cooking oil 50 with the filter 110 and the second end 134 of the suction line 130 is positioned outside the fry pot 18 such that the suction line 130 extends from the first end 132 upwardly through the top opening 35 of the fry pot 18 to the second end 134 to suspend the filter 110 within the fry pot 18. To this end, a portion of the suction line 130 extends generally along the front wall 56 of the fry pot 18 (see FIG. 3).

As shown in FIG. 3, at least a portion of the filter 110 is disposed within the cold zone 64, and specifically within the crumb basket 52, when the filter assembly 12 is in the lowered position. The crumb basket 52 may be configured to center the filter 110 within the fry pot 18, for example. In any event, a base 112 of the filter 110 is positioned proximate to the base 82 of the crumb basket 52 such that a gap 158 is formed between the base 112 of the filter 110 and the base 82 of the crumb basket 52. The gap 158 provides a space below the filter 110 for crumbs to collect in the crumb basket 52 to avoid blinding of the filter 110. In the embodiment shown, a majority of the filter 110 (i.e., 50% or more) is located within the cold zone 64 when in the lowered position. A top edge 114 of the filter 110 may be located outside of the cold zone 64. In an alternative embodiment, the entirety of the filter 110 may be located within the cold zone 64.

The handle 116 of the filter assembly 12 may be used by an operator, for example, to move the filter assembly 12 between the lowered position (e.g., FIG. 3) and the raised position (e.g., FIG. 4), as indicated by directional arrows A3 of FIG. 4. When in the raised positioned, the slide member 148 may be fully extended from the stationary member 150 to remove the filter assembly 12 from the cooking oil 50. The filter 110 may then be cleaned or the filter assembly 12 replaced, for example. When raised, the filter assembly 12 remains generally directly over the crumb basket 52 so that any filter cake that is scraped or that otherwise falls from the filter 110 falls into the crumb basket 52. The telescopic section 118 of the inlet line 96 may include a compression nut, sleeve, or other suitable locking mechanism capable of maintaining the raised position of the filter assembly 12.

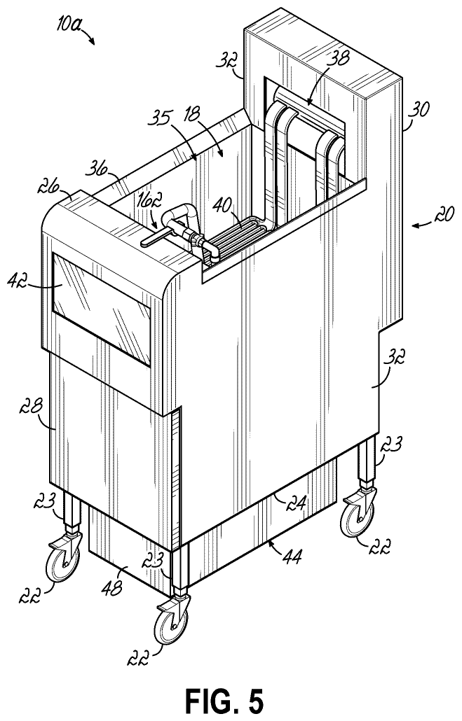

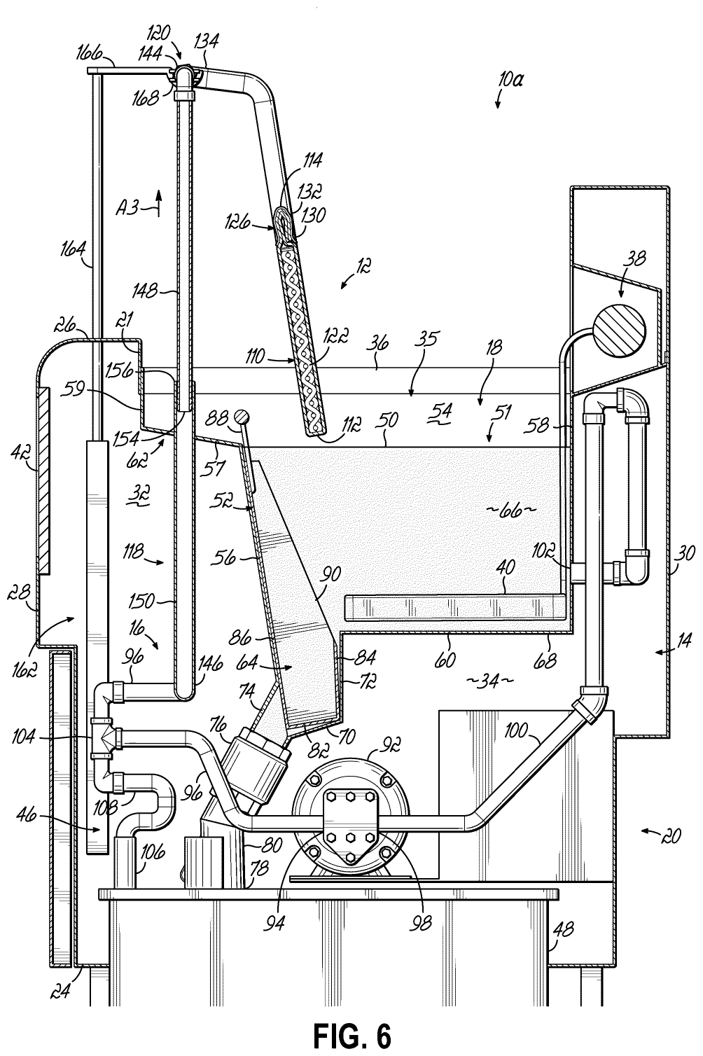

Referring now to FIGS. 5 and 6, wherein like numerals represent like features described herein, a fryer 10a is shown in accordance with a second embodiment of the present invention. The primary difference between the fryer 10a of this embodiment and the fryer 10 of the embodiment described above with respect to FIGS. 1-4 is that the filter assembly 12 is movable between the lowered position and the raised position by a linear actuator 162, rather than manually. While a linear actuator 162 is shown and described, it will be understood that other devices may be used to mechanically move the filter assembly 12 between the lowered position and the raised position. For example, a belt drive, a screw drive, or any other suitable device for imparting linear motion to the filter assembly 12. The linear actuator 162 may be operated with a switch or may be responsive to stored programs for commanding operation of the linear actuator 162, as described in further detail below.

As best shown in FIG. 6, the linear actuator 162 is mounted to the fryer housing 20 near the front 28 and includes an actuatable piston rod 164 that is configured to extend generally in parallel with the telescopic section 118 of the inlet line 96. The linear actuator 162 is located in the interior 34 of the fryer 10a, but may be located elsewhere on the fryer 10a, and may be located on the telescopic section 118, for example. Located at a distal end of the piston rod 164 is a support arm 166 configured to support the filter assembly 12. In that regard, the support arm 166 includes a cradle 168 that is configured to receive the second end 134 of the suction line 130 of the filter assembly 12. In that regard, the suction line 130 rests in the cradle 168 and is not permanently attached to the cradle 168, for example. That way, the filter assembly 12 may be removed for replacement during fryer operations, if needed. During operation of the linear actuator 162, the cradle 168 engages the suction line 130 to drive upward or vertical movement of the filter assembly 12 to the raised position, as shown. Operation of the linear actuator 162 to retract the piston rod 164 permits the filter assembly 12 to drop back to the lowered position. Operation of the linear actuator 162 may be controlled by an operator via control panel 42.

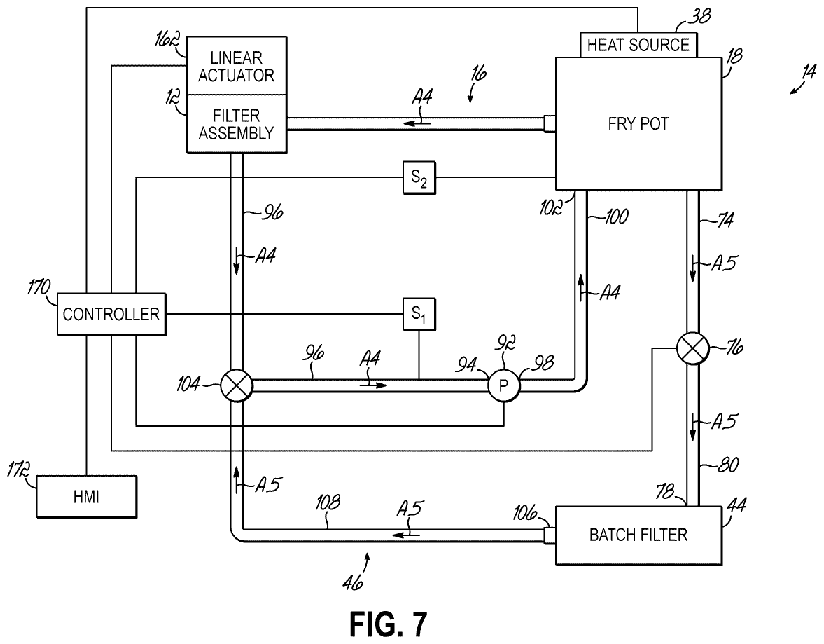

With reference to FIG. 7, details of the exemplary oil filtration system 14 of the fryers 10, 10a, and more particularly the continuous oil filtration loop 16 and the batch filtration loop 46, are shown diagrammatically. In that regard, the continuous oil filtration loop 16 includes, in sequence, the fry pot 18, the filter assembly 12, the diverter valve 104, and the pump 92. Directional arrows A4 illustrate the flow of cooking oil 50 through the continuous oil filtration loop 16.

The batch filtration loop 46 includes, in sequence, the fry pot 18, the batch filter assembly 44, the diverter valve 104, and the pump 92. Directional arrows A5 generally illustrate the flow of cooking oil 50 through the batch filtration loop 46. The inlet line 96 may include one or more sensors, including as a suction pressure sensor S₁ for measuring a negative pressure in the inlet line 96 from the pump 92 drawing cooking oil 50 into the filter 110 of the filter assembly 12 during continuous filter mode. The fry pot 18 may include one or more sensors, including a thermostat or thermocouple S₂ for measuring a temperature of the cooking oil 50 held in the fry pot 18. The oil filtration system 14 includes a controller 170 that is operatively coupled to components of the fryer 10, 10a, such as the linear actuator 162, heat source 38, diverter valve 104, pump 92, drain valve 76, an HMI 172, and sensors S₁, S₂, to permit controlling of the operation of the fryer 10, 10a, as will be described in further detail below.

When the fryer 10, 10a is running in the continuous filter mode, as described above, the suction pressure sensor S₁ measures the suction pressure in the inlet line 96 that is generated by the pump 92 drawing cooking oil 50 through the filter assembly 12. When the suction pressure is normal (i.e., high), the HMI 172 is configured to show a green status (or green light). A normal suction pressure may be approximately 29 PSI, for example, and indicates that the filter 110 is clean. When the suction pressure drops to below 20 PSI for example, such as approximately 15 PSI, the HMI 172 is configured to show a yellow status (or yellow light) to indicate a caution status (i.e., weakening suction pressure). A caution status indicates to an operator that the filter 110 may need to be cleaned or replaced soon. When the suction pressure drops to below 15 PSI, such as approximately 10 PSI (i.e., low), for example, the HMI 172 is configured to show a red status (or red light), indicating that the filter 110 needs to be cleaned or replaced. In addition to the visual indicators described above, the HMI 172 may be configured to generate an accompanying audible indicator, such as a voice message, to relay information to the operator.

In one embodiment, the controller 170 may be configured to operate the linear actuator 162 to automatically remove the filter assembly 12 from the chamber 51 of the fry pot 18 when the suction pressure drops to 10 PSI (red status), for example. When the actuator 162 is energized and lifting the filter assembly 12 from the lowered position to the raised position, the pump 92 will continue to operate to apply a vacuum to the filter 110 to suck the oil out of the filter 110. As a result, the filter 110 is no longer oil-saturated which yields a safer, cleaner replacement operation. To this end, once the filter assembly 12 reaches the raised position, the pump 92 may shut off so that the filter assembly 12 can be replaced, for example.

In another embodiment, the thermocouple S₂ is configured to continually monitor a temperature of the cooking oil 50 held in the chamber 51 of the fry pot 18. When a temperature drop in the cooking oil 50 associated with cold comestibles being inserted into the chamber 51 of the fryer 10, 10a is detected by the thermocouple S₂, the pump 92 is energized to run the fryer 10, 10a in continuous filter mode for a period of time. For example, when a temperature of the cooking oil 50 falls below a setpoint temperature value, such as to 330° F., the pump 92 is energized to run the fryer 10, 10a in continuous filter mode for a period of time. To this end, the pump 92 may run for a period of 5 minutes beyond the time that the fryer 10, 10a begins an idling pattern or has returned to a cooking setpoint temperature at which point the pump 92 is de-energized (shut off). This allows the cooking oil 50 to clarify or polish. The pump 92 may remain de-energized until another temperature drop in the cooking oil 50 associated with cold comestibles being inserted into the fryer 10, 10a is detected at which point the pump 92 will once again be energized. Operation of the cooking oil filtration system 14 in this regard will save energy and allow the oil 50 to rest. To this end, the exemplary time value of 5 minutes can be varied in other embodiments of the invention.

While the various principles of the invention have been illustrated by way of describing various exemplary embodiments, and while such embodiments have been described in considerable detail, there is no intention to restrict, or in any way limit, the scope of the appended claims to such detail. Additional advantages and modifications will readily appear to those skilled in the art. Further, various changes could be made in the above-described aspects and exemplary embodiments without departing from the scope of the invention, and it is intended that all matter contained in the above description shall be interpreted as illustrative and not in a limiting sense.

What is claimed is:

1. A fryer for cooking comestibles, the fryer comprising:
a fry pot having a chamber configured to hold a volume of cooking oil for cooking comestibles; and
an oil filtration system for filtering the cooking oil, comprising:
a filter assembly including a filter connected to a suction line, the filter assembly being movable between a lowered position wherein the filter is immersed within the cooking oil and a raised position wherein the filter is removed from the cooking oil; and
pump having an inlet port and an outlet port, the inlet port being fluidly connected with the suction line of the filter assembly by an inlet line to receive filtered cooking oil from the filter assembly and the outlet port being fluidly connected to the fry pot with a return line to direct filtered cooking to the chamber of the fry pot, the pump being configured to apply a vacuum to the filter assembly to draw unfiltered cooking oil from the fry pot and through the filter assembly for filtering and to pump the filtered cooking oil back to the chamber of the fry pot;
wherein the pump is configured to apply the vacuum to the filter assembly while the filter assembly is moved between the lowered position and the raised position.

2. The fryer of claim 1, wherein the filter assembly is configured to be substantially vertically oriented in the fry pot.

3. The fryer of claim 1, wherein the filter assembly is suspended in the fry pot by the suction line.

4. The fryer of claim 1, wherein the inlet line of the oil filtration system includes a telescopic section that provides for vertical movement of the filter assembly relative to the fry pot.

5. The fryer of claim 4, further comprising a liner actuator configured to move the filter assembly between the lowered position and the raised position.

6. The fryer of claim 1, wherein the oil filtration system further comprises a suction pressure sensor configured to measure a suction pressure in the inlet line.

7. The fryer of claim 6, further comprising a controller operatively coupled to the oil filtration system and a human machine interface operatively coupled to the controller, the controller being configured to operate the oil filtration system as follows:
monitor the suction pressure in the inlet line; and
if the suction pressure drops below a first suction pressure value, generate a low suction pressure notification at the human machine interface.

8. The fryer of claim 7, further comprising a liner actuator configured to move the filter assembly between the lowered position and the raised position, wherein the controller is configured to operate the oil filtration system with the additional following steps:
if the suction pressure drops below the first suction pressure value, operate the linear actuator to move the filter assembly from the lowered position to the raised position.

9. The fryer of claim 1, wherein the inlet line includes a 2-way diverter valve fluidly connected to a batch filter unit by a batch filter line, wherein operation of the 2-way diverter valve places the batch filter unit in fluid communication with the inlet port of the pump.

10. A fryer for cooking comestibles, the fryer comprising:
a fry pot including a chamber having cooking zone located at a first end of the chamber of the fry pot and a cold zone located at an opposite second end of the chamber of the fry pot, the cold zone and the cooking zone defining a volume of the chamber of the fry pot configured to hold cooking oil for cooking comestibles;
at least one heating element located in the cooking zone of the chamber of the fry pot;
a crumb basket configured to be located in the cold zone of the chamber of the fry pot; and
a filter assembly suspended within the fry pot by a suction line such that a filter of the filter assembly is partially positioned within the cold zone for filtering cooking oil.

11. The fryer of claim 10, wherein the filter assembly is configured to be substantially vertically oriented in the fry pot.

12. The fryer of claim 10, wherein the filter is positioned at least partially within the crumb basket.

13. The fryer of claim 10, wherein a majority of the filter is positioned within the cold zone.

14. The fryer of claim 10, wherein the cold zone extends downwardly from the cooking zone to form a deepest point of the fry pot.

15. The fryer of claim 10, wherein the fry pot further includes a drain that extends from a base wall portion of the fry pot that defines the cold zone.

16. The fryer of claim 10, wherein the filter is an envelope filter that defines a pocket configured to receive a separator screen, the pocket of the filter being in fluid communication with the suction line.

17. A fryer for cooking comestibles, the fryer comprising:
a fry pot having a chamber configured to hold a volume of cooking oil for cooking comestibles; and
an oil filtration system for filtering the cooking oil, comprising:
a filter assembly disposed within the fry pot such that a filter of the filter assembly is immersed within the cooking oil, the filter assembly including a suction line having a first end connected to the filter and a second end positioned outside the fry pot such that the suction line extends from the first end upwardly through a top opening of the fry pot to the second end; and
a pump having an inlet port and an outlet port, the inlet port being fluidly connected to the second end of the suction line of the filter assembly by an inlet line to receive filtered cooking oil from the filter assembly and the outlet port being fluidly connected to the fry pot with an outlet line to return filtered cooking to the chamber of the fry pot;
the pump being configured to circulate the cooking oil through the oil filtration system by applying a vacuum to the filter assembly to draw unfiltered cooking oil held in the chamber of the fry pot through the filter assembly for filtering and pumping filtered cooking oil back to the chamber of the fry pot.

18. The fryer of claim 17, wherein the filter assembly is configured to be substantially vertically oriented in the fry pot.

19. The fryer of claim 17, wherein the inlet line of the oil filtration system includes a telescopic section that provides for vertical movement of the filter assembly relative to the fry pot.

20. The fryer of claim 19, wherein the filter assembly is movable between a lowered position wherein the filter is immersed within the cooking oil and a raised position wherein the filter is removed from the cooking oil.

21. The fryer of claim 17, wherein the oil filtration system further comprises a suction pressure sensor configured to measure a suction pressure in the inlet line.

22. The fryer of claim 21, further comprising a controller operatively coupled to the oil filtration system and a human machine interface operatively coupled to the controller, the controller being configured to operate the oil filtration system as follows:
monitor the suction pressure in the inlet line; and
if the suction pressure drops below a first suction pressure value, generate a low suction pressure notification at the human machine interface.

23. The fryer of claim 20, further comprising a liner actuator configured to move the filter assembly between a lowered position wherein the filter is immersed within the cooking oil and a raised position wherein the filter is removed from the cooking oil, wherein the controller is configured to operate the oil filtration system as follows:
monitor the suction pressure in the inlet line; and
if the suction pressure drops below the first suction pressure value, operate the linear actuator to move the filter assembly from the lowered position to the raised position.

24. The fryer of claim 17, wherein the inlet line includes a 2-way diverter valve fluidly connected to a batch filter unit by a batch filter line, wherein operation of the 2-way diverter valve places the batch filter unit in fluid communication with the inlet port of the pump.
